(19) United States
(12) Patent Application Publication
(10) Pub. No.: US 2025/0153546 A1
(43) Pub. Date: May 15, 2025

(54) THERMAL MANAGEMENT SYSTEM FOR VEHICLE

(71) Applicant: Dong Hee Industrial Co. Ltd., Ulsan (KR)

(72) Inventors: Seung Cheol Han, Hwaseong, Gyeonggi-do (KR); Byeong Jin Shin, Gimcheon, Gyeongsangbuk-do (KR); Do Yeop Kim, Suwon, Gyeonggi-do (KR); Geon Eung Lee, Suwon, Gyeonggi-do (KR); Sang Dae Kim, Suwon, Gyeonggi-do (KR); Dong Dae Park, Suwon, Gyeonggi-do (KR)

(21) Appl. No.: 18/719,908

(22) PCT Filed: Dec. 16, 2022
(86) PCT No.: PCT/KR2022/020574

§ 371 Date: Jun. 14, 2024

(30) Foreign Application Priority Data
Dec. 16, 2021 (KR) 10-2021-0180842

(51) Int. Cl. B60H 1/32; B60H 1/00; B60H 1/03; B60H 1/14; H01M 10/613; H01M 10/625; H01M 10/6569; H01M 10/663

(52) U.S. Cl. CPC B60H 1/32284; B60H 1/00278; B60H 1/00392; B60H 1/034; B60H 1/143; H01M 10/613; H01M 10/625; H01M 10/6569; H01M 10/663; B60H 2001/00307; H01M 2220/20

(57) ABSTRACT

Disclosed is a thermal management system for a vehicle, the thermal management system including a refrigerant line in which a refrigerant circulates, the refrigerant line having a closed loop including a compressor, a condensing core, an expansion valve, and an evaporation core, a first coolant line in which a coolant flows while circulating between the evaporation core and an electronic component of a vehicle, a second coolant line in which the coolant flows while circulating between the condensing core and a radiator, and a fluid line in which a non-conductive fluid flows while circulating between an interior air conditioning part and the condensing core or the evaporation core, in which a heating core of the interior air conditioning part and a battery are connected, and the non-conductive fluid is introduced into a battery housing and is in direct thermal conduction with a battery cell.

### TECHNICAL FIELD

### Cross-Reference to Related Application

This application claims priority to and the benefit of Korean Patent Application No. 10-2021-0180842 filed in the Korean Intellectual Property Office on Dec. 16, 2021, the entire contents of which are incorporated herein by reference.

### TECHNICAL FIELD

The present invention relates to a thermal management system for a vehicle, which is capable of significantly improving cooling and heating efficiency by performing integrated thermal management on an electric vehicle or the like by using a non-conductive fluid that exchanges heat directly with a battery.

### BACKGROUND ART

Recently, environmental-friendly vehicles such as electric vehicles have come into wide use to solve environmental issues caused by internal combustion engine vehicles. In the case of the internal combustion engine vehicle in the related art, waste heat from an engine may be used to heat the interior, which does not require energy for a separate heating process. However, because the electric vehicle has no engine, i.e., a heat source, separate energy needs to be required to perform the heating process, which causes a deterioration in fuel economy. Further, the deterioration in fuel economy decreases a travelable distance of the electric vehicle and causes the vehicle to be frequently charged, which causes discomfort.

Meanwhile, as the vehicle is motorized, there is an additional need to manage not only heat in the interior of the vehicle, but also heat of electronic components such as a high-voltage battery and a motor. That is, in the case of the electric vehicle, the interior space, the battery, and the electronic components have different needs for air conditioning, and thus there is required a technology capable of maximally saving energy by independently coping with and efficiently and cooperatively managing the different needs. Therefore, an integrated vehicle heat management concept has been proposed in order to improve thermal efficiency by independently managing heat of the respective components and integrating the heat management of the entire vehicle. As the related art, there is KR 10-2021-0022220 A.

In order to perform the integrated thermal management on the vehicle, a refrigerant and a coolant exchange heat with each other, and the coolant is used to exchange heat indirectly with the battery or the electronic component. However, this method is very inefficient, and cooling or heating efficiency actually deteriorates.

The foregoing explained as the background is intended merely to aid in the understanding of the background of the present invention, and is not intended to mean that the present invention falls within the purview of the related art that is already known to those skilled in the art.

### DISCLOSURE

### Technical Problem

The present invention has been made in an effort to solve the above-mentioned problem, and an object of the present invention is to provide a thermal management system for a vehicle, which is capable of significantly improving cooling and heating efficiency by performing integrated thermal management on an electric vehicle or the like by using a non-conductive fluid that exchanges heat directly with a battery.

### Technical Solution

In order to achieve the above-mentioned object, the present invention provides a thermal management system for a vehicle, the thermal management system including: a refrigerant line in which a refrigerant circulates, the refrigerant line having a closed loop including a compressor, a condensing core, an expansion valve, and an evaporation core: a first coolant line in which a coolant flows while circulating between the evaporation core and an electronic component of a vehicle; a second coolant line in which the coolant flows while circulating between the condensing core and a radiator; and a fluid line in which a non-conductive fluid flows while circulating between an interior air conditioning part and the condensing core or the evaporation core, in which a heating core of the interior air conditioning part and a battery are connected, and the non-conductive fluid is introduced into a battery housing and is in direct thermal conduction with a battery cell.

The condensing core and the evaporation core of the refrigerant line may exchange heat with the coolant or the non-conductive fluid.

An additional radiator may be connected in parallel to the electronic component of the first coolant line.

The condensing core, the heating core of the interior air conditioning part, and the battery may be connected in series through the fluid line.

The evaporation core, a cooling core of the interior air conditioning part, and the battery may be connected in parallel through the fluid line.

An electric heater may be provided at a downstream point of the battery in the fluid line.

The heating core of the interior air conditioning part may have an outlet directed toward the battery, an inlet into which the fluid is introduced from the battery, and an inlet into which the fluid is introduced from the condensing core.

The battery may have an outlet, an inlet into which the fluid is introduced from the heating core of the interior air conditioning part, and an inlet into which the fluid is introduced from the evaporation core.

In a cooling mode, the condensing core may dissipate heat through the radiator of the second coolant line, and the cooling core of the interior air conditioning part and the battery may be cooled by the fluid line and the evaporation core.

In a heating mode, the heating core of the interior air conditioning part and the battery may be heated by the fluid line and the condensing core, and the evaporation core may absorb heat through the electronic component of the first coolant line.

In a maximum heating mode, the heating core of the interior air conditioning part, the battery, and an electric heater of the fluid line may constitute a closed loop.

In a dehumidification mode, a cooling core of the interior air conditioning part may constitute a closed loop together with the evaporation core, and the heating core of the interior air conditioning part and the battery may constitute a closed loop together with the condensing core.

In a maximum dehumidification mode, a cooling core of the interior air conditioning part may constitute a closed loop together with the evaporation core, the heating core of the interior air conditioning part, the battery, and the electric heater may constitute a closed loop, and the condensing core may dissipate heat through the radiator of the second coolant line.

### Advantageous Effects

According to the thermal management system for a vehicle of the present invention, it is possible to significantly improve cooling and heating efficiency by performing the integrated thermal management on the electric vehicle or the like by using the non-conductive fluid that exchanges heat directly with the battery.

### DESCRIPTION OF DRAWINGS

FIG. 1 is a view illustrating a cooling mode of a thermal management system for a vehicle according to an embodiment of the present invention.

FIG. 2 is a view illustrating a heating mode of the thermal management system for a vehicle according to the embodiment of the present invention.

FIG. 3 is a view illustrating a maximum heating mode of the thermal management system for a vehicle according to the embodiment of the present invention.

FIG. 4 is a view illustrating a dehumidification mode of the thermal management system for a vehicle according to the embodiment of the present invention.

FIG. 5 is a view illustrating a maximum dehumidification mode of the thermal management system for a vehicle according to the embodiment of the present invention.

### MODE FOR INVENTION

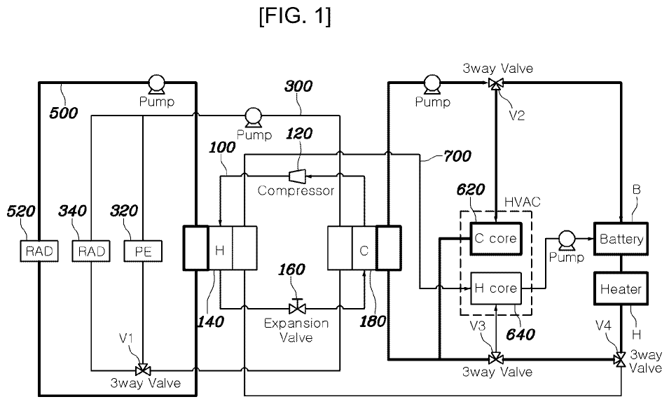

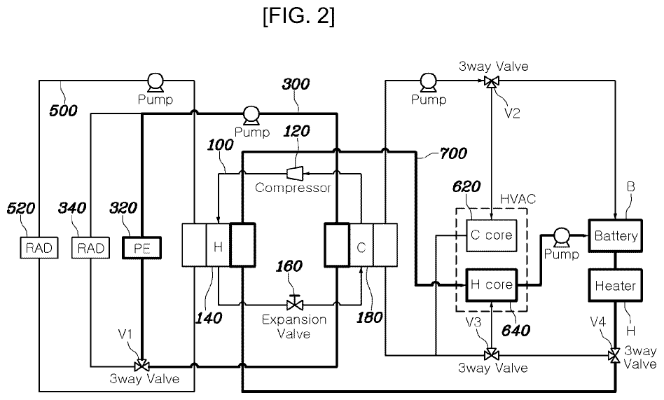

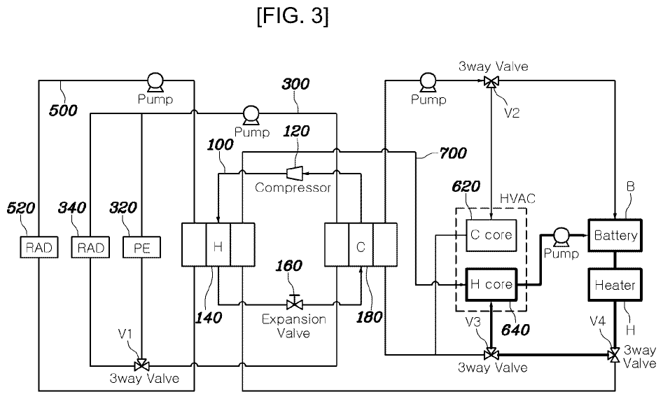

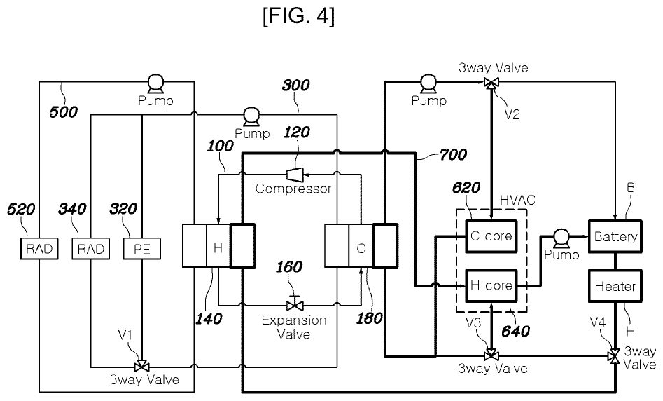

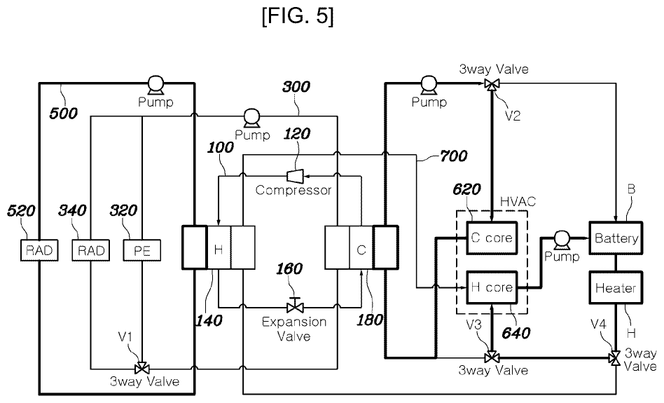

FIG. 1 is a view illustrating a cooling mode of a thermal management system for a vehicle according to an embodiment of the present invention, FIG. 2 is a view illustrating a heating mode of the thermal management system for a vehicle according to the embodiment of the present invention, FIG. 3 is a view illustrating a maximum heating mode of the thermal management system for a vehicle according to the embodiment of the present invention, FIG. 4 is a view illustrating a dehumidification mode of the thermal management system for a vehicle according to the embodiment of the present invention, and FIG. 5 is a view illustrating a maximum dehumidification mode of the thermal management system for a vehicle according to the embodiment of the present invention.

FIG. 1 is a view illustrating the cooling mode of the thermal management system for a vehicle according to the embodiment of the present invention. The system of the present invention will be described with reference to the drawing.

The thermal management system for a vehicle according to the present invention includes: a refrigerant line 100 in which a refrigerant circulates, the refrigerant line 100 having a closed loop including a compressor 120, a condensing core 140, an expansion valve 160, and an evaporation core 180; a first coolant line 300 in which a coolant flows while circulating between the evaporation core 180 and an electronic component 320 of a vehicle; a second coolant line 500 in which the coolant flows while circulating between the condensing core 140 and a radiator 520; and a fluid line 700 in which a non-conductive fluid flows while circulating between the condensing core 140 or the evaporation core 180 and an interior air conditioning part, in which a heating core 640 of the interior air conditioning part and a battery B are connected, and the non-conductive fluid is introduced into a battery housing and is in direct thermal conduction with a battery cell.

In the present invention, the compressor 120, the condensing core 140, the expansion valve 160, and the evaporation core 180 constitute a closed loop by using efficiency of a refrigerant system and allow the refrigerant to circulate therein. Various types of refrigerants, which are used for vehicles in the related art, may be applied. Further, heat from the condensing core, which is generated in the refrigerant line of the closed loop, may be used, or cold air from the evaporation core may be used, which may remarkably reduce the amount of use of the refrigerant.

Meanwhile, instead of the refrigerant, the coolant flows through the first coolant line 300. The coolant flows in the first coolant line 300 while circulating between the evaporation core 180 and the electronic component 320 of the vehicle. Further, the coolant flows in the second coolant line 500 while circulating between the condensing core 140 and the radiator 520.

Meanwhile, the fluid line 700 of the present invention is a line that uses the non-conductive fluid that is not electrically conductive. A fluid, which may be injected directly into the electronic component 320 or the battery B and exchange heat directly with the battery cell or the like, is used. Examples of this fluid may include Novec™ Engineered Fluid of 3M. This fluid operates in one or two phases, has minimal electrical conductivity, and is capable of heat exchange. Even though the fluid penetrates directly into the interior of electronic components, efficient heating and cooling may be performed without the risk of short circuits.

The non-conductive fluid flows in the fluid line 700 of the present invention and circulates between the interior air conditioning part and the condensing core 140 or the evaporation core 180. The heating core 640 of the interior air conditioning part and the battery B are connected, and the non-conductive fluid is introduced into the battery housing and is in direct thermal conduction with the battery cell.

Specifically, the evaporation core 180 and the condensing core 140 of the refrigerant line 100 may exchange heat with the coolant or the non-conductive fluid. The condensing core 140 and the evaporation core 180 may each have two cores provided at two opposite sides. Therefore, one side may exchange heat with the coolant, and the other side may exchange heat with the non-conductive fluid. This structure may remarkably reduce the amount of use of the refrigerant.

In addition, an additional radiator 340 may be connected in parallel to the electronic component 320 of the first coolant line 300 through a three-way valve V1. The additional radiator 340 may be used as a heat pump system that absorbs outside waste heat.

Further, the condensing core 140, the heating core 640 of the interior air conditioning part, and the battery B may be connected in series through the fluid line 700. The evaporation core 180, a cooling core 620 of the interior air conditioning part, and the battery B may be connected in parallel through the fluid line 700.

In addition, an electric heater H may be provided at a downstream point of the battery B in the fluid line 700 and meet heating needs beyond the heat pump.

Meanwhile, the heating core 640 of the interior air conditioning part may have an outlet directed toward the battery B, an inlet into which the fluid is introduced from the battery B, and an inlet into which the fluid is introduced from the condensing core 140. Further, the battery B may have an outlet, an inlet into which the fluid is introduced from the heating core 640 of interior air conditioning part, and an inlet into which the fluid is introduced from the evaporation core 180. That is, the two inlets and the single outlet are provided in each of the battery B and the heating core 640 of the interior air conditioning part, and all the inlets and outlets are structured such that the non-conductive fluid is directly introduced and discharged.

Specifically, FIG. 1 is a view illustrating a cooling mode of the thermal management system for a vehicle according to the embodiment of the present invention. In the cooling mode, the condensing core 140 may dissipate heat through the radiator 520 of the second coolant line 500, and the cooling core 620 of the interior air conditioning part and the battery B may be cooled by the fluid line 700 and the evaporation core 180. In the cooling mode, the condensing core 140 dissipates heat through the radiator 520 of the second coolant line 500, such that the evaporation core 180 is cooled. Further, the cooling core 620 and the battery B are cooled through the fluid line 700 by using the cooling of the evaporation core 180. The cooling between the two components is adjusted by a three-way valve V2. The evaporation core 180, the heating core 640, a blower, and a door are provided in the interior air conditioning part and discharge cold air or warm air to the interior. Further, the non-conductive fluid is not supplied to the heating core 640 by a three-way valve V3 to be described below, and the fluid is not transmitted to the condensing core 140 by another three-way valve V4. The non-conductive fluid is supplied directly into the battery housing of the battery B, and the fluid exchanges heat directly with the battery cell, which significantly improves the cooling efficiency and improves the overall energy efficiency of the vehicle.

FIG. 2 is a view illustrating a heating mode of the thermal management system for a vehicle according to the embodiment of the present invention. In the heating mode, the heating core 640 of the interior air conditioning part and the battery B may be heated by the fluid line 700 and the condensing core 140, and the evaporation core 180 may absorb heat through the electronic component 320 of the first coolant line 300. In this case, waste heat of the electronic component 320, such as an inverter or a motor, is recovered by the evaporation core, and the heating core 640 of the interior air conditioning part and the battery B are sequentially heated, such that the heating is performed by the heat pump.

FIG. 3 is a view illustrating a maximum heating mode of the thermal management system for a vehicle according to the embodiment of the present invention. In the maximum heating mode, the heating core 640 of the interior air conditioning part, the battery B, and the electric heater H of the fluid line may constitute the closed loop. In this case, the cooling implemented by the heat pump is insufficient, and the heating core 640 of the interior air conditioning part and the battery B are heated only by the electric heater. Likewise, the electric heater directly heats the non-conductive fluid.

FIG. 4 is a view illustrating a dehumidification mode of the thermal management system for a vehicle according to the embodiment of the present invention. In the dehumidification mode, the cooling core 620 of the interior air conditioning part may constitute the closed loop together with the evaporation core 180, and the heating core 640 of the interior air conditioning part and the battery B may constitute the closed loop together with the condensing core 140. In the dehumidification mode, both the heating core 640 of the interior air conditioning part and the cooling core 620 may operate, such that both the absolute humidity and the relative humidity of air to be discharged to the interior may be reduced, and the air may be supplied.

Further, FIG. 5 is a view illustrating a maximum dehumidification mode of the thermal management system for a vehicle according to the embodiment of the present invention. In the maximum dehumidification mode, the cooling core 620 of the interior air conditioning part may constitute the closed loop together with the evaporation core 180, and the heating core 640 of the interior air conditioning part, the battery B, and the electric heater H may constitute the closed loop, such that the condensing core 140 may dissipate heat through the radiator 520 of the second coolant line. In this case, the heating implemented by the heat pump is not sufficient, and the heating is performed by the electric heater H.

According to the thermal management system for a vehicle of the present invention, it is possible to significantly improve cooling and heating efficiency by performing the integrated thermal management on the electric vehicle or the like by using the non-conductive fluid that exchanges heat directly with the battery.

While the specific embodiments of the present invention have been illustrated and described, it will be obvious to those skilled in the art that the present invention may be variously modified and changed without departing from the technical spirit of the present invention defined in the appended claims.

1. A thermal management system for a vehicle, the thermal management system comprising:
a refrigerant line in which a refrigerant circulates, the refrigerant line having a closed loop including a compressor, a condensing core, an expansion valve, and an evaporation core;
a first coolant line in which a coolant flows while circulating between the evaporation core and an electronic component of a vehicle;
a second coolant line in which the coolant flows while circulating between the condensing core and a radiator; and
a fluid line in which a non-conductive fluid flows while circulating between an interior air conditioning part and the condensing core or the evaporation core, in which a heating core of the interior air conditioning part and a battery are connected, and the non-conductive fluid is introduced into a battery housing and is in direct thermal conduction with a battery cell.

2. The thermal management system of claim 1, wherein the condensing core and the evaporation core of the refrigerant line exchange heat with the coolant or the non-conductive fluid.

3. The thermal management system of claim 1, wherein an additional radiator is connected in parallel to the electronic component of the first coolant line.

4. The thermal management system of claim 1, wherein the condensing core, the heating core of the interior air conditioning part, and the battery are connected in series through the fluid line.

5. The thermal management system of claim 1, wherein the evaporation core, a cooling core of the interior air conditioning part, and the battery are connected in parallel through the fluid line.

6. The thermal management system of claim 1, wherein an electric heater is provided at a downstream point of the battery in the fluid line.

7. The thermal management system of claim 1, wherein the heating core of the interior air conditioning part has an outlet directed toward the battery, an inlet into which the fluid is introduced from the battery, and an inlet into which the fluid is introduced from the condensing core.

8. The thermal management system of claim 1, wherein the battery has an outlet, an inlet into which the fluid is introduced from the heating core of the interior air conditioning part, and an inlet into which the fluid is introduced from the evaporation core.

9. The thermal management system of claim 1, wherein in a cooling mode, the condensing core dissipates heat through the radiator of the second coolant line, and the cooling core of the interior air conditioning part and the battery are cooled by the fluid line and the evaporation core.

10. The thermal management system of claim 1, wherein in a heating mode, the heating core of the interior air conditioning part and the battery are heated by the fluid line and the condensing core, and the evaporation core absorbs heat through the electronic component of the first coolant line.

11. The thermal management system of claim 1, wherein in a maximum heating mode, the heating core of the interior air conditioning part, the battery, and an electric heater of the fluid line constitute a closed loop.

12. The thermal management system of claim 1, wherein in a dehumidification mode, a cooling core of the interior air conditioning part constitutes a closed loop together with the evaporation core, and the heating core of the interior air conditioning part and the battery constitute a closed loop together with the condensing core.

13. The thermal management system of claim 1, wherein in a maximum dehumidification mode, a cooling core of the interior air conditioning part constitutes a closed loop together with the evaporation core, the heating core of the interior air conditioning part, the battery, and the electric heater constitute a closed loop, and the condensing core dissipates heat through the radiator of the second coolant line.
